(19) United States
(12) Patent Application Publication
(10) Pub. No.: US 2010/0200791 A1
(43) Pub. Date: Aug. 12, 2010

(54) Valve Having High Pressure and Low Pressure Seals

(75) Inventors: Heng Yung, Stewartsville, NJ (US); Richard W. Weston, Nazareth, PA (US); Kerry L. DeWitt, Oxford, PA (US); Richard A. Bucher, Jamison, PA (US)

Correspondence Address: Ballard Spahr LLP, SUITE 1000, 999 PEACHTREE STREET, ATLANTA, GA, 30309-3915, US

(73) Assignee: Victaulic Company, Easton, PA (US)

(21) Appl. No.: 12/697,734

(22) Filed: Feb. 1, 2010

Related U.S. Application Data
(60) Provisional application No. 61/150,740, filed on Feb. 7, 2009.

(51) Int. Cl. F16K 3/20; F16K 5/06

(52) U.S. Cl. 251/172; 251/315.01; 251/174

(57) ABSTRACT

A valve having high and low pressure seals. The valve has a housing in which is mounted a valve closing member having a sealing surface which faces an opening in the housing. A low pressure seal surrounds the opening and is biased into contact with the sealing surface. A high pressure seal also surrounds the opening. Pressure in the valve pushes the closing member against the low pressure seal, which moves toward the opening until the closing member contacts the high pressure seal.

### CROSS REFERENCE TO RELATED APPLICATIONS

This application is based upon and claims priority to U.S. Provisional Application No. 61/150,740, filed on Feb. 7, 2009.

### FIELD OF THE INVENTION

This invention relates to valves for control of fluid flow, and especially to ball valves capable of operating over a wide pressure range with an extended time between servicing.

### BACKGROUND

Ball valves suffer from a number of disadvantages. The sealing capability of ball valves relies largely on the preload between the ball and the seal. The ball is usually made of metal and the seal is usually a much softer elastomeric ring positioned within the housing of the valve in contact with the ball. The larger the pressure within the valve, the larger this preload must be for the valve to effect a fluid tight seal. Large preloads induce large stresses in the seal. Furthermore, if the valve is subjected to high pressure when closed, additional stress is placed on the seal because the ball is free to move over a limited range of motion in response to the pressure. The ball is thus forced even tighter against the seal. Under such sustained stresses the seal tends to creep and lose its resiliency, thereby losing its preload and with it, the ability to seal under pressures lower than the high pressures to which the valve is exposed.

Another disadvantage is related to the torque required to operate the valve. Large preloads require proportionally large torques to effect valve opening and closing. Furthermore, if a valve is not operated for an extended period of time the seal will tend to adhere to the ball. Significantly greater torque is required to operate a valve in which a bond has formed between the seal and the ball. The initial operating torque for a valve having this condition can be 3 to 4 times the normal operating torque. For a large manually operated valve without a geared actuator it may not be possible to operate the valve without damaging its component parts.

These problems coupled with the significant wear between moving parts under high preload result in a relatively short operating life of the valve, which must be serviced frequently to avoid leaks. There is clearly a need for a ball valve, as well as for other types of valves, which avoid the aforementioned disadvantages.

### SUMMARY

The invention concerns a valve for controlling flow of a fluid. The valve comprises a housing having an inlet and an outlet. A valve closing member is positioned within the housing. The valve closing member is movable between a closed configuration, preventing flow of the fluid from the inlet to the outlet, and an open configuration, allowing flow of the fluid from the inlet to the outlet. The valve closing member comprises a sealing surface positioned in facing relation with the outlet when in the closed configuration. A first seal is positioned within the housing surrounding the outlet. A spring element is positioned within the housing. The spring element biases the first seal into contact with the sealing surface to effect a first fluid tight seal up to a first fluid pressure within the valve. The spring element permits the first seal to move toward the outlet in response to fluid pressure within the valve against the valve closing member. A second seal is positioned within the housing surrounding the outlet. The second seal contacts the sealing surface to effect a second fluid tight seal up to a second fluid pressure within the valve when fluid pressure within the valve moves the closing member toward the outlet and into contact with the second seal. The second fluid pressure is higher than the first fluid pressure

In one embodiment, the first seal comprises a first ring and the second seal comprises a second ring. The first ring may be surrounded by the second ring, or the second ring may be surrounded by the first ring. The spring element may comprise an O-ring formed of an elastomeric material. In another embodiment the second ring comprises a first and a second lobe extending circumferentially around the second ring. The first lobe is attached to the second lobe in spaced apart relation and defines an annular cavity therebetween. In this embodiment the spring element and the first ring are positioned within the annular cavity.

The valve closing member may comprise a ball rotatably mounted within the housing. The ball has a duct therethrough alignable with the inlet and the outlet when the closing member is in the open configuration.

Additionally, the sealing surface of the valve closing member is also positioned in facing relation with the inlet when the closing member is in the closed configuration. A third seal may be positioned within the housing surrounding the inlet, and a second spring element is positioned within the housing. The second spring element biases the third seal into contact with the sealing surface to effect a third fluid tight seal up to a third fluid pressure within the valve. The second spring element permits the third seal to move toward the inlet in response to fluid pressure within the valve against the valve closing member. A fourth seal also may be positioned within the housing surrounding the inlet. The fourth seal contacts the sealing surface to effect a fourth fluid tight seal up to a fourth fluid pressure within the valve higher than the third fluid pressure when fluid pressure within the valve moves the closing member toward the inlet and into contact with the fourth seal.

The third seal may comprise a third ring and the fourth seal may comprise a fourth ring. The third ring may be surrounded by the fourth ring, or the fourth ring may be surrounded by the third ring. The second spring element may comprise an O-ring formed of an elastomeric material. In another embodiment, the fourth ring may comprise a third and a fourth lobe extending circumferentially around the fourth ring. The third lobe is attached to the fourth lobe in spaced apart relation and defines an annular cavity therebetween. The spring element and the third ring are positioned within the annular cavity defined by the third and fourth lobes.

The valve closing member may comprise a ball rotatably mounted within the housing. The ball has a duct therethrough alignable with the inlet and the outlet when the closing member is in the open configuration.

The invention further encompasses a valve for controlling flow of a fluid. The valve comprising a housing having a first and a second opening and a valve closing member positioned within the housing. The valve closing member is movable between a closed configuration preventing flow of the fluid between the first and the second openings, and an open configuration allowing flow of the fluid between the first and the second openings. The valve closing member comprises a sealing surface positioned in facing relation with the first opening when in the closed configuration. A plurality of seals are positioned within the housing. The plurality of seals comprises at least a first seal positioned within the housing surrounding the first opening, the first seal being in contact with the sealing surface and effecting a first fluid tight seal up to a first fluid pressure within the valve, and a second seal positioned within the housing surrounding the first opening, the second seal contacting the sealing surface to effect a second fluid tight seal up to a second fluid pressure within the valve higher than the first fluid pressure.

In one embodiment, the first seal comprises a first ring and the second seal comprises a second ring. The first ring may be surrounded by the second ring or the second ring may be surrounded by the first ring. A spring element may be positioned within the housing. The spring element may bias the first or the second seal into contact with the sealing surface. Alternately, two separate spring elements may be positioned within the housing to bias both the first and second seals toward the sealing surface.

In an embodiment of the valve, the sealing surface of the valve closing member is also positioned in facing relation with the second opening when the closing member is in the closed configuration. A third seal may be positioned within the housing surrounding the second opening, the third seal being in contact with the sealing surface and effecting a third fluid tight seal up to a third fluid pressure within the valve. A fourth seal may be positioned within the housing surrounding the second opening, the fourth seal contacting the sealing surface to effect a fourth fluid tight seal up to a fourth fluid pressure within the valve higher than the third fluid pressure.

In one embodiment, the third seal comprises a third ring and the fourth seal comprises a fourth ring. The third ring may be surrounded by the fourth ring or the fourth ring may be surrounded by the third ring. Additional spring elements may be positioned within the housing. A spring element may bias either the third or the fourth seal into contact with the sealing surface. Alternately, two separate spring elements may be positioned within the housing to bias both the third and fourth seals toward the sealing surface.

### BRIEF DESCRIPTION OF THE DRAWINGS

FIG. 1 is a longitudinal sectional view of an embodiment of a valve according to the invention;

FIGS. 2 and 3 show a detail, taken from circle 2 on FIG. 1, of a portion of the valve on an enlarged scale;

FIG. 4 is an exploded isometric view of the valve shown in FIG. 1;

FIG. 5 is a longitudinal sectional view of another embodiment of a valve according to the invention;

FIGS. 6 and 7 show a detail, taken from circle 6 on FIG. 5, showing a portion of the valve on an enlarged scale;

FIG. 8 is a longitudinal sectional view of another embodiment of a valve according to the invention;

FIGS. 9 and 10 show a detail, taken from circle 9 on FIG. 8, showing a portion of the valve on an enlarged scale; and

FIGS. 11 through 22 show partial longitudinal sectional views of examples of alternate embodiments of valves according to the invention.

### DETAILED DESCRIPTION OF EMBODIMENTS

FIG. 1 shows a longitudinal sectional view of a valve 10 according to the invention. By way of example, valve 10 is a ball valve, but other types of valves, such as plug valves and eccentric butterfly valves may also have the sealing characteristics described herein. Valve 10 comprises a housing 12 having an inlet 14 and an outlet 16. The valve 10 also has a valve closing member 18, in this example a ball 20 positioned within the housing 12. Ball 20 has a sealing surface 22 formed in this example by the ball's outer surface. There is also a duct 24 through the ball 20. The ball is movable in rotation between a closed configuration (shown) wherein the sealing surface 22 is in facing relation with the outlet 16, and an open configuration wherein the duct 24 is aligned with the inlet and outlet to allow fluid to flow through the valve from the inlet 14 to the outlet 16. Rotation of the valve is effected by a valve stem 26 which passes through a bonnet 28 on the valve housing 12. A seal 30 between the stem 26 and bonnet 28 prevents leakage of fluid past the stem.

Two seals, 32 and 34 are positioned within housing 12 surrounding the outlet 16. Seal 32 is a low pressure seal, designed to contact the sealing surface 22 of ball 20 and provide a fluid tight seal at relatively low pressure, and up to a maximum low pressure depending on the design of the valve 10. Seal 34 is a high pressure seal which contacts the sealing surface 22 of ball 20 at pressures close to but below the maximum low pressure and provides a fluid tight seal up to a maximum high pressure determined by the material properties of the high pressure seal 34. Example maximum low pressures range between about 200 psi gauge and about 500 psi gauge, while example maximum high pressures range between about 800 psi gauge and about 3000 psi gauge.

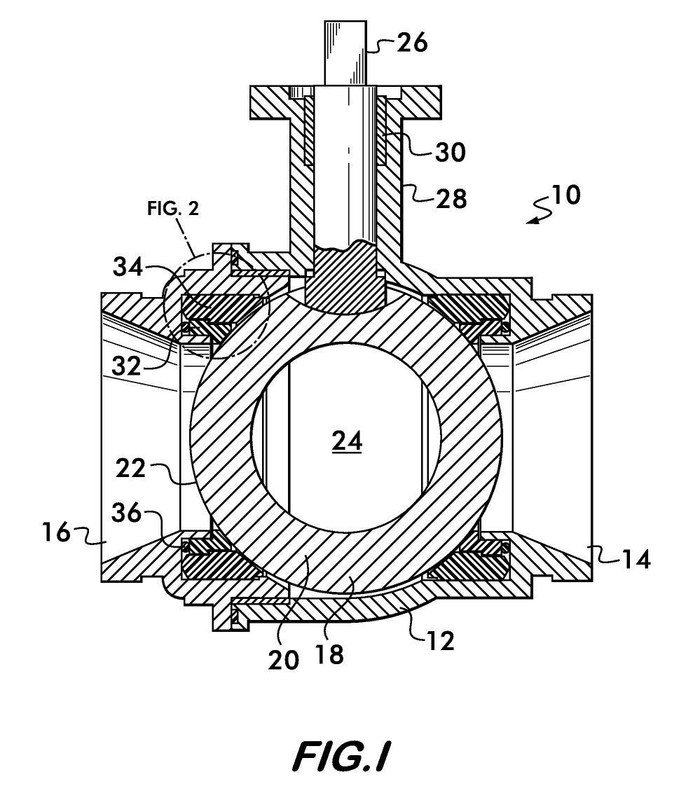

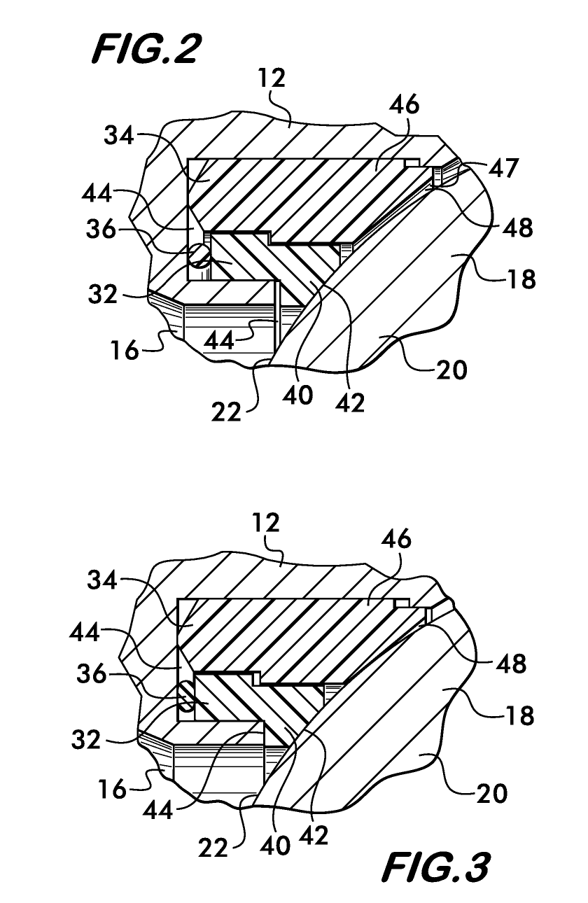

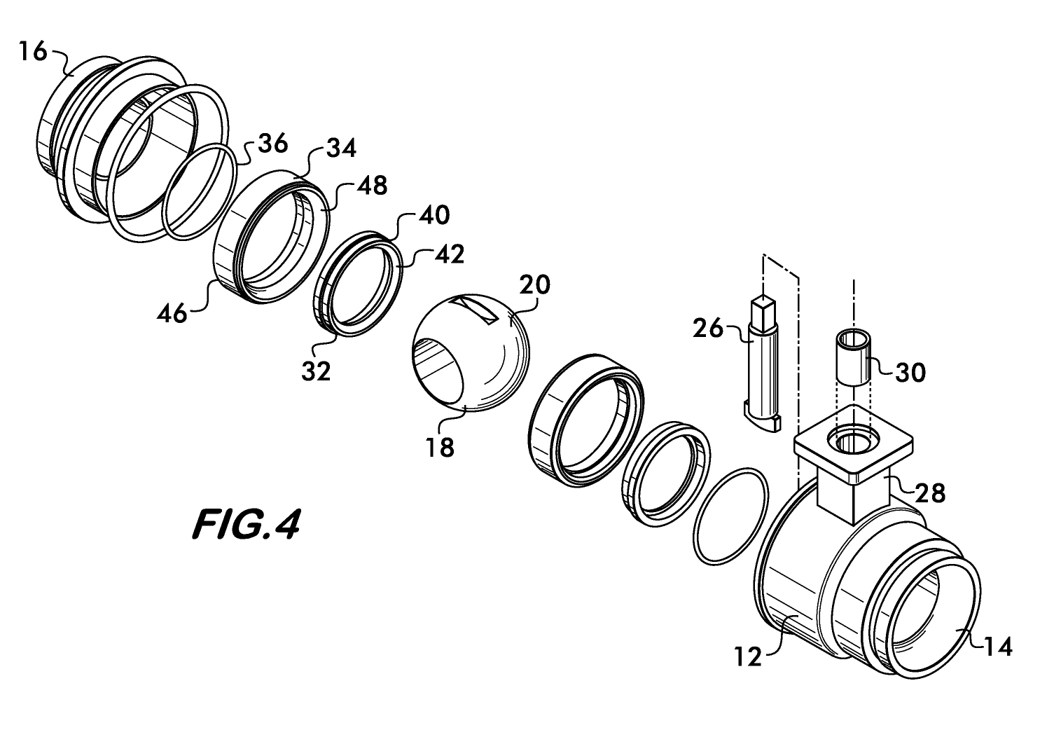

FIGS. 2 and 3 show in detail how the low pressure and high pressure seals 32 and 34 cooperate to provide a fluid tight seal from the low pressure range up through the maximum high pressure. As shown in FIG. 2, low pressure seal 32 is biased into contact with sealing surface 22 by a spring element 36 positioned between the seal 32 and the housing 12. The stiffness of spring element 36 is designed to apply a predetermined force to the low pressure seal 32 to bias it into contact with the sealing surface 22, the biasing force of the spring substantially determining the maximum low pressure to which the low pressure seal will seal and ensure fluid tightness. The low pressure seal is designed to have negligible deformation as it is compressed against the sealing surface 22, and derives almost all of its sealing capability from the spring biasing force applied by the spring element 36. In a practical design, the spring element 36 may be, for example, an O-ring, as shown in the exploded view of FIG. 4. Other types of spring elements include compression springs, disc springs, wave springs, rubber springs and gaskets. As further shown in FIG. 4, the low pressure seal 32 comprises a ring 40 which surrounds the outlet 16 and has a face 42 contoured to contact the spherical sealing surface 22 (see also FIG. 2). The low pressure seal 32 may be made from materials such as elastomer, plastics, PTFE, PFA, and CTFE.

As shown in FIG. 2, a space 44 is provided within the valve housing 12 which permits the low pressure seal 32 to move toward the outlet, restrained only by the biasing action of the spring element 36. As the pressure within a closed valve 10 increases on the side of inlet 14, the valve closing member 18 (ball 20) is forced toward the outlet 16, moving the low pressure seal 32 by compressing spring element 36 as illustrated in FIG. 3. Ball 20 eventually moves into contact with the high pressure seal 34. As shown in FIG. 4, the high pressure seal 34 is also a ring 46 which has a face 48 that is adapted to contact the sealing surface 22 on ball 20. With the ball 20 compressed against it as shown in FIG. 3, the high pressure seal 34 provides the fluid tight seal for pressures above the maximum low pressure up to which the low pressure seal 32 is effective. At the higher pressures, the high pressure seal 34 not only provides a fluid-tight seal, but also helps bear the load from the ball 20, relieving the low pressure seal 32 of some of the load and thereby delaying and reducing the degree of permanent deformation of the low pressure seal 32 due to creep as well as reducing the likelihood of the ball adhering to the seals by spreading out the load and reducing the contact force. In a practical design, ring 46 is formed of plastics such as ultra high molecular weight polyethylene, Delrin PEEK, PPS, Torlon as well as metals such as 316 and 316L stainless steel and beryllium copper.

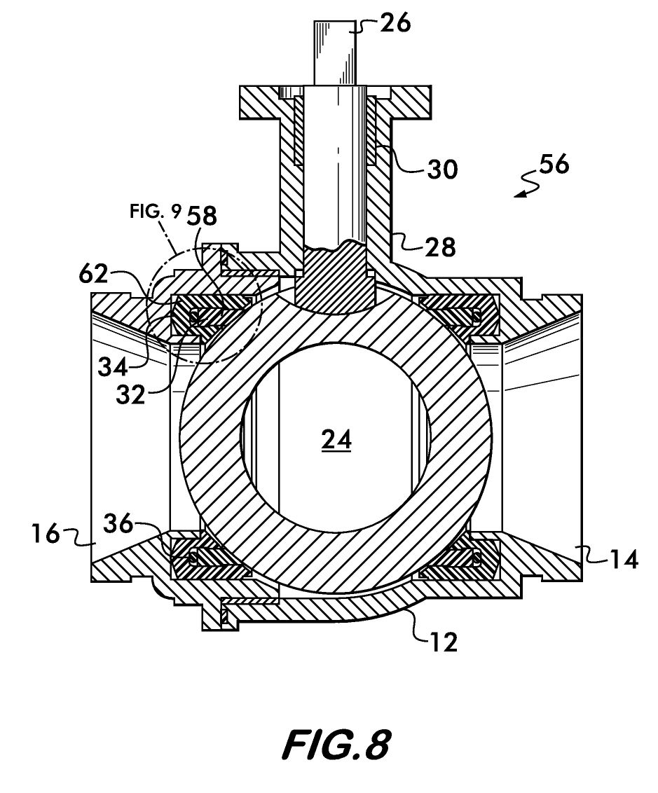

As shown in FIG. 1, the configuration of high and low pressure seals 34 and 32 may also be positioned surrounding the inlet 14 as well as the outlet 16. This configuration makes the valve 10 symmetric with respect to fluid flow, thereby providing the advantages of the combination of high and low pressure seals regardless of the direction of fluid flow or the manner in which the valve is installed in a fluid handling system such as a piping network. Additional embodiments, described below, may also be configured with the combination of high and low pressure seals surrounding both the inlet and outlet, as shown in FIGS. 5 and 8. For such symmetric valves the distinction between the inlet and outlet is meaningless, and they may be regarded as openings in the housing 12 thorough which fluid may enter or exit the valve.

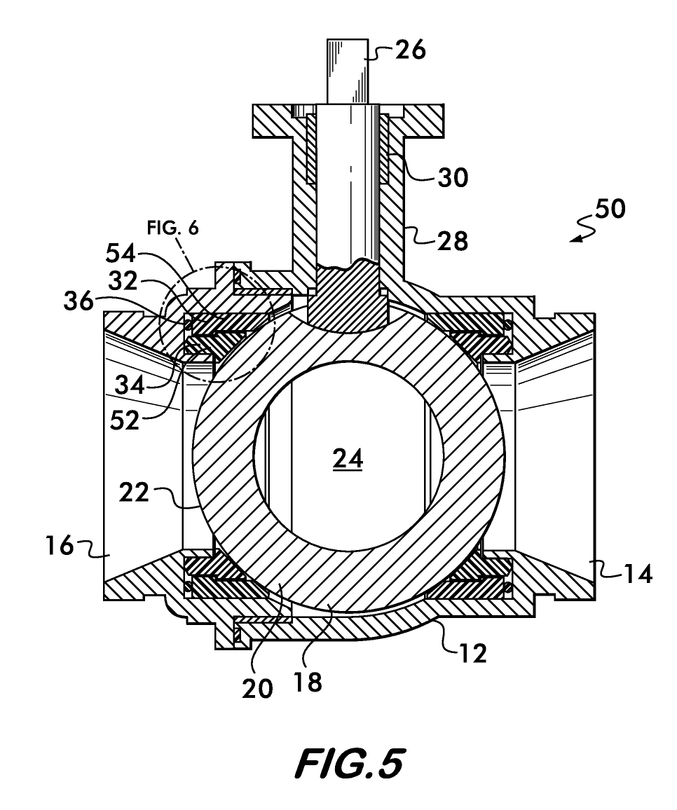

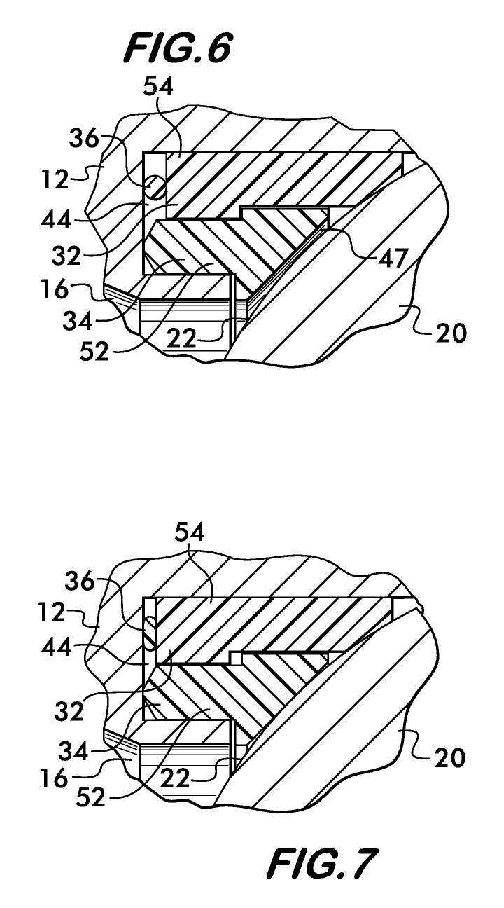

In the valve embodiment 10 shown in FIGS. 1-4, the low pressure seal 32, formed by ring 40, is positioned within the ring 46 which forms the high pressure seal 34. FIGS. 5-7 show another valve embodiment 50 according to the invention, wherein the high pressure seal 34 comprises a ring 52 that is positioned within a ring 54 that forms the low pressure seal 32, readily identifiable by the spring element 36 which biases the low pressure seal against the sealing surface 22 of the ball 20. Again, as shown in FIG. 6, the low pressure seal 32 (ring 54) is biased into contact with the ball 20 by the spring element 36, and space 44 is provided between the ring 54 and the housing 12 to permit the ring to move toward the outlet 16 as the pressure within the valve increases. There is also a gap 47 between the ball 20 and the high pressure seal 34, ring 52, which closes as the low pressure seal 32 is pushed toward the outlet 16 by the pressure. As shown in FIG. 7, under higher pressure the ball 20 contacts both the high and low pressure seals 34 and 32 thereby achieving the same advantages as described for the previous embodiment.

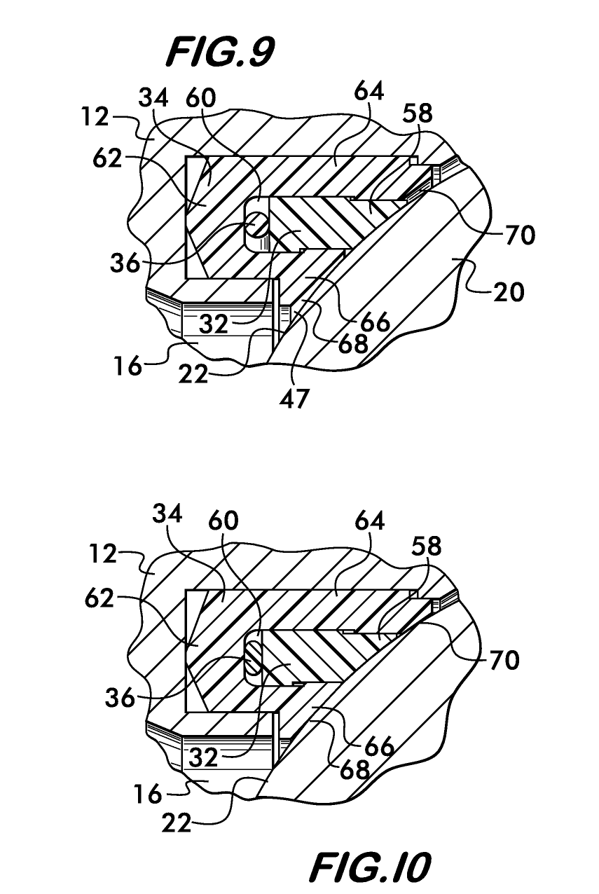

FIGS. 8-10 illustrate another valve embodiment 56 wherein the spring element 36 and the low pressure seal 32, formed by a ring 58, are positioned within an annular cavity 60 formed by the high pressure seal 34, in this example, ring 62. Ring 62 has outer and inner lobes 64 and 66 which are attached to one another in spaced apart relation to surround and define the annular cavity 60 in which the low pressure seal 32 is positioned. This example works in a manner similar to the previously described embodiments, in that the low pressure seal 32 (ring 58) is biased into contact with the ball 20 by spring element 36, also positioned within the annular cavity 60, and seals up to a maximum low pressure determined largely by the stiffness of the spring element. There is again a gap 47 between the ball 20 and the high pressure seal 34 (ring 62) at the lower pressures. As the pressure within the valve 56 increases, the low pressure seal 32 moves toward the outlet 16 and the ball 20 closes the gap and contacts one or both of the outer and inner lobes 64 and 66 of the ring 62, which provide the sealing effect for pressures above the maximum lower pressure. One or both lobes 64 and 66 may include respective faces 68 and 70 adapted to contact the surface 22 of the valve closing member 18 (ball 20 in this example).

Spring biasing the low pressure seal provides several advantages. Stress on the low pressure seal is limited by the stiffness of the spring element, not the stiffness of the seal itself. Therefore, the low pressure seal is less likely to creep and lose resiliency when subjected to high pressure, and will seal effectively under lower pressures for a longer period (determined mainly by the spring element characteristics) than a seal that must withstand the full stresses induced by repeated or prolonged high pressure conditions. Thus the frequency of valve servicing to replace leaking seals is decreased. Because the contact force between the low pressure seal and the valve closing member is limited by the spring element, the low pressure seal is less likely to adhere to the valve closing member and require large torques to break it free to close the valve. Furthermore, the torque generally required to operate the valve may be kept within reasonable limits by a judicious choice of the spring element stiffness, as higher biasing force requires greater torque. If the biasing force can be tuned to the minimum required for the expected low pressure maximum then the required torque will also be a minimum.

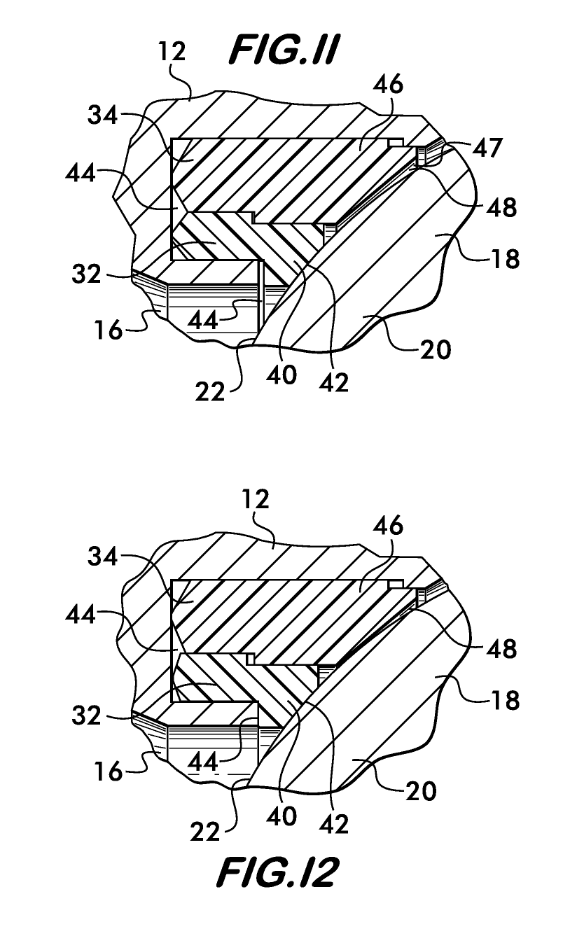

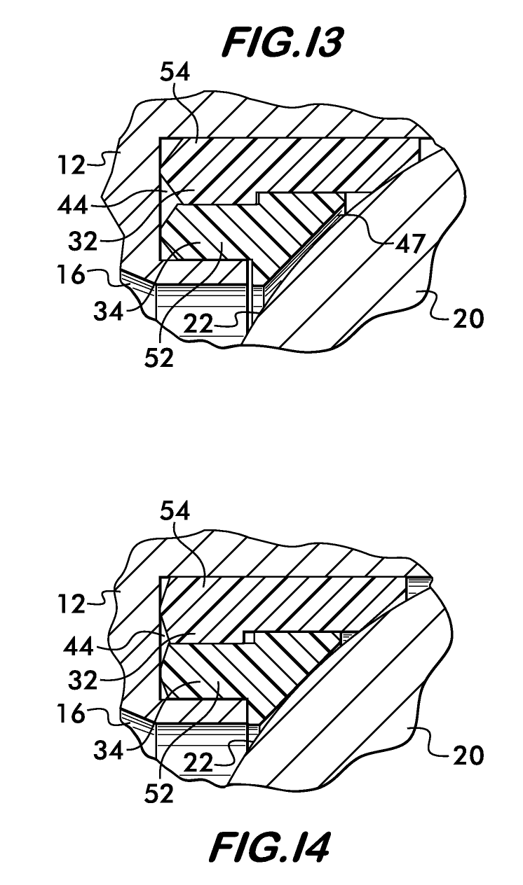

While the use of discrete spring elements affords excellent control over the behavior of the seals in the valve with respect to determining the high and low pressure ranges over which the valve is effective, it is also possible to achieve the advantages noted above by using seals having different material stiffnesses, thereby obviating the need for discrete spring elements in certain applications. FIG. 11 shows such an embodiment, wherein both the low pressure and high pressure seals 32 and 34 are formed of materials having different moduli of elasticity. For example, the low pressure seal 32 may be an elastomer having a lower durometer than the high pressure seal 34, which may also be an elastomer. The lower stiffness of the low pressure seal permits it to deform when the closing member 18 is subject to pressure, forcing the sealing surface 22 against the seal 32 as shown in FIG. 12. The deformation of the low pressure seal 32 allows the sealing surface 22 to engage the high pressure seal 34 and effect a fluid tight seal over the high pressure range of the valve. FIGS. 11 and 12 depict an example embodiment wherein the high pressure seal 34 comprises a ring 46 which surrounds the low pressure seal 32, also in the form of a ring 40. Such a configuration is useful, for example, in a ball valve as shown in FIG. 4. An alternate embodiment of a valve not having discrete spring elements is illustrated in FIGS. 13 and 14, wherein the low pressure seal 32 comprises a ring 54 which surrounds the high pressure seal 34, formed as a ring 52. FIG. 13 shows the seal in operation over the low pressure range, while FIG. 14 illustrates operation over the high pressure range wherein the low pressure seal 32 is deformed and the sealing surface 22 has moved into contact with the high pressure seal 34. The seals may have different stiffnesses, the stiffness being controlled by the choice of materials for the seals as well as the shape of the seal.

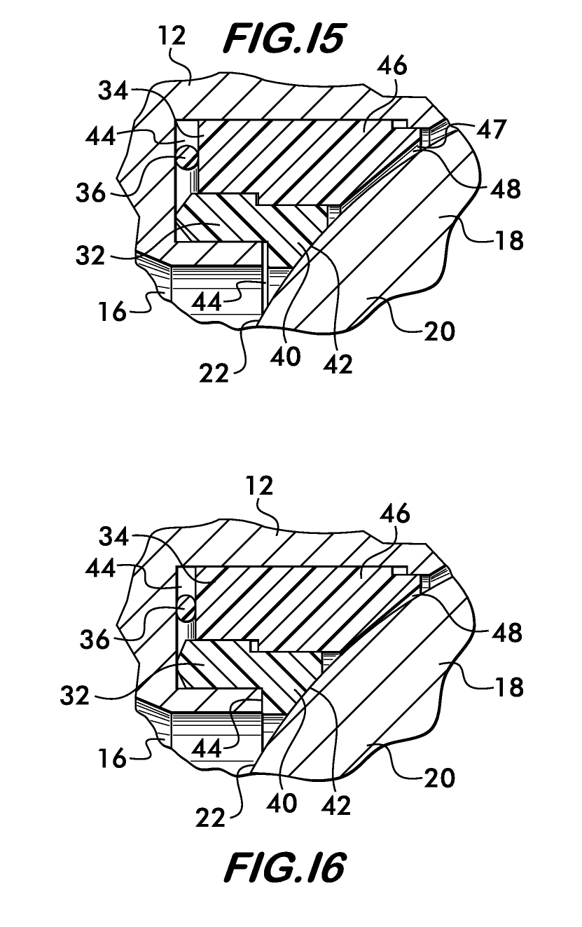

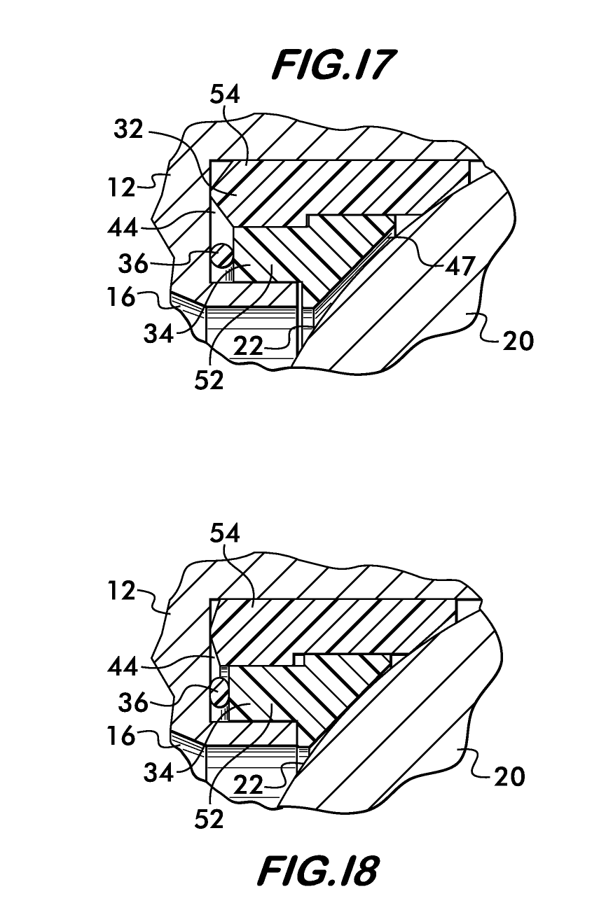

Further control of the sealing ranges of the valve may be achieved by using a discrete spring element 36 in conjunction with the high pressure seal 34. An example of this embodiment is shown in FIGS. 15 and 16, wherein the spring element 36 is positioned within space 44 between the housing 12 and the high pressure seal 34. In this example, the low pressure seal 32 (in the form of a ring 40) engages the sealing surface 22 of the closing member 18 to provide the fluid tight seal over the low pressure range as shown in FIG. 15. With an increase in pressure, as shown in FIG. 16, the low pressure seal deforms and the sealing surface engages the high pressure seal 34, in this example represented by the ring 46. Spring element 36 deforms over the high pressure range to help limit and equalize the contact force between the seals and the closing member. FIGS. 15 and 16 show an embodiment wherein the high pressure seal 34, biased by the spring element 36, surrounds the low pressure seal 32. In another embodiment, shown in FIGS. 17 and 18, the low pressure seal 32 surrounds the high pressure seal 34.

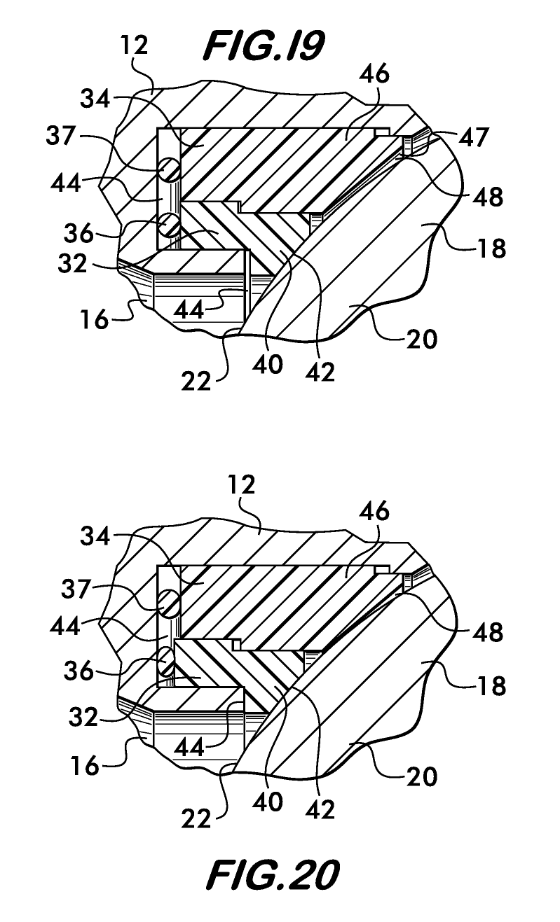

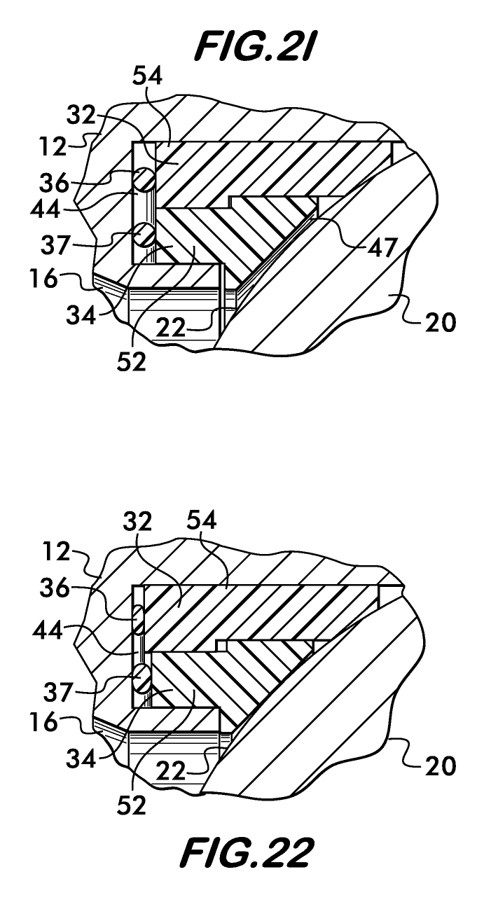

It may also be advantageous to bias both the high and low pressure seals 34 and 32 using separate discrete spring elements. An example of such a valve embodiment is shown in FIG. 19, wherein the low pressure seal 32, which could be a ring 40 for example, is biased into contact with the sealing surface 22 of closing member 18 by spring element 36, positioned within space 44 between the seal and the housing 12. High pressure seal 34 is biased toward the sealing surface 22 by a second spring element 37, also positioned within space 44. In this example the high pressure seal comprises a ring 46 which surrounds the ring 40. FIG. 19 shows the valve operating over the low pressure range wherein the low pressure seal contacts and seals against the sealing surface 22, the spring element 36 providing the biasing force. In FIG. 20 the valve is shown operating in the high pressure range as illustrated by contact between the sealing surface 22 and the high pressure seal 34, along with deformation of both spring elements 36 and 37. Alternately, as shown in FIGS. 21 and 22, the low pressure seal 32 may comprise a ring 54 which surrounds the high pressure seal 34, formed by a ring 52. Again, two discrete spring elements 37 and 36 are used to bias both the high and low pressure seals 34 and 32, respectively, toward the sealing surface 22. The spring elements 36 and 37 may have the same or different spring constants as necessary for the particular high and low pressure ranges. Stiffness of the spring elements may be determined by the choice of material and shape.

Valves as described above are expected to realize significant advantages in reduced maintenance, lower actuation torques, and efficacy of sealing over a larger pressure range when compared with prior art valves.

What is claimed is:

1. A valve for controlling flow of a fluid, said valve comprising:
a housing having an inlet and an outlet;
a valve closing member positioned within said housing, said valve closing member being movable between a closed configuration preventing flow of said fluid from said inlet to said outlet, and an open configuration allowing flow of said fluid from said inlet to said outlet, said valve closing member comprising a sealing surface positioned in facing relation with said outlet when in said closed configuration;
a first seal positioned within said housing surrounding said outlet;
a spring element positioned within said housing, said spring element biasing said first seal into contact with said sealing surface to effect a first fluid tight seal up to a first fluid pressure within said valve;
a second seal positioned within said housing surrounding said outlet, said second seal contacting said sealing surface to effect a second fluid tight seal up to a second fluid pressure within said valve higher than said first fluid pressure when fluid pressure within said valve moves said closing member toward said outlet and into contact with said second seal.

2. The valve according to claim 1, wherein said first seal comprises a first ring and said second seal comprises a second ring.

3. The valve according to claim 2, wherein said first ring is surrounded by said second ring.

4. The valve according to claim 2, wherein said second ring is surrounded by said first ring.

5. The valve according to claim 2, wherein said spring element comprises an O-ring formed of an elastomeric material.

6. The valve according to claim 2, wherein said second ring comprises:
a first and a second lobe extending circumferentially around said second ring, said first lobe being attached to said second lobe in spaced apart relation and defining an annular cavity therebetween, said spring element and said first ring being positioned within said annular cavity.

7. The valve according to claim 1, wherein said valve closing member comprises a ball rotatably mounted within said housing, said ball having a duct therethrough alignable with said inlet and said outlet when said closing member is in said open configuration.

8. The valve according to claim 1, further comprising:
said sealing surface of said valve closing member being positioned in facing relation with said inlet when said closing member is in said closed configuration;
a third seal positioned within said housing surrounding said inlet;
a second spring element positioned within said housing, said second spring element biasing said third seal into contact with said sealing surface to effect a third fluid tight seal up to a third fluid pressure within said valve;
a fourth seal positioned within said housing surrounding said inlet, said fourth seal contacting said sealing surface to effect a fourth fluid tight seal up to a fourth fluid pressure within said valve higher than said third fluid pressure when fluid pressure within said valve moves said closing member toward said inlet and into contact with said fourth seal.

9. The valve according to claim 8, wherein said third seal comprises a third ring and said fourth seal comprises a fourth ring.

10. The valve according to claim 9, wherein said third ring is surrounded by said fourth ring.

11. The valve according to claim 9, wherein said fourth ring is surrounded by said third ring.

12. The valve according to claim 9, wherein said second spring element comprises an O-ring formed of an elastomeric material.

13. The valve according to claim 9, wherein said fourth ring comprises:
a third and a fourth lobe extending circumferentially around said fourth ring, said third lobe being attached to said fourth lobe in spaced apart relation and defining an annular cavity therebetween, said spring element and said third ring being positioned within said annular cavity defined by said third and fourth lobes.

14. The valve according to claim 8, wherein said valve closing member comprises a ball rotatably mounted within said housing, said ball having a duct therethrough alignable with said inlet and said outlet when said closing member is in said open configuration.

15. A ball valve for controlling flow of a fluid, said ball valve comprising:
a housing having a first and a second opening;
a valve closing member positioned within said housing, said valve closing member comprising a ball having a duct therethrough, said ball being rotatable between a closed configuration, wherein said duct is not in fluid communication with said first and second openings, and an open configuration, wherein said duct is in fluid communication with said first and second openings, said ball having a sealing surface positioned in facing relation with said first opening when in said closed configuration;
a first ring-shaped seal positioned within said housing surrounding said first opening;
a spring element positioned within said housing, said spring element biasing said first ring-shaped seal into contact with said sealing surface to effect a first fluid tight seal up to a first fluid pressure within said valve;
a second ring-shaped seal positioned within said housing surrounding said first opening, said second ring-shaped seal contacting said sealing surface to effect a second fluid tight seal up to a second fluid pressure within said valve higher than said first fluid pressure when fluid pressure within said valve moves said ball toward said first opening and into contact with said second ring-shaped seal.

16. The ball valve according to claim 15, wherein said first ring-shaped seal is surrounded by said second ring-shaped seal.

17. The ball valve according to claim 15, wherein said second ring-shaped seal is surrounded by said first ring-shaped seal.

18. The ball valve according to claim 15, wherein said spring element comprises an O-ring formed of an elastomeric material.

19. The ball valve according to claim 15, wherein said second ring-shaped seal comprises:
a first and a second lobe extending circumferentially around said second ring-shaped seal, said first lobe being attached to said second lobe in spaced apart relation and defining an annular cavity therebetween, said spring element and said first ring-shaped seal being positioned within said annular cavity.

20. The ball valve according to claim 15, further comprising:
said sealing surface of said ball being positioned in facing relation with said second opening when said ball is in said closed configuration;
a third ring-shaped seal positioned within said housing surrounding said second opening;
a second spring element positioned within said housing, said second spring element biasing said third ring-shaped seal into contact with said sealing surface to effect a third fluid tight seal up to a third fluid pressure within said valve;
a fourth seal positioned within said housing surrounding said second opening, said fourth seal contacting said sealing surface to effect a fourth fluid tight seal up to a fourth fluid pressure within said valve higher than said third fluid pressure when fluid pressure within said valve moves said ball toward said second opening and into contact with said fourth seal.

21. The ball valve according to claim 20, wherein said third ring-shaped seal is surrounded by said fourth ring-shaped seal.

22. The ball valve according to claim 20, wherein said fourth ring-shaped seal is surrounded by said third ring-shaped seal.

23. The ball valve according to claim 20, wherein said second spring element comprises an O-ring formed of an elastomeric material.

24. The ball valve according to claim 20, wherein said fourth ring-shaped seal comprises:
a third and a fourth lobe extending circumferentially around said fourth ring-shaped seal, said third lobe being attached to said fourth lobe in spaced apart relation and defining an annular cavity therebetween, said second spring element and said third ring-shaped seal being positioned within said annular cavity defined by said third and fourth lobes.

25. A valve for controlling flow of a fluid, said valve comprising:
a housing having a first and a second opening;
a valve closing member positioned within said housing, said valve closing member being movable between a closed configuration preventing flow of said fluid between said first and said second openings, and an open configuration allowing flow of said fluid between said first and said second openings, said valve closing member comprising a sealing surface positioned in facing relation with said first opening when in said closed configuration;
a plurality of seals positioned within said housing, said plurality of seals comprising at least:
a first seal positioned within said housing surrounding said first opening, said first seal being in contact with said sealing surface and effecting a first fluid tight seal up to a first fluid pressure within said valve;
a second seal positioned within said housing surrounding said first opening, said second seal contacting said sealing surface to effect a second fluid tight seal up to a second fluid pressure within said valve higher than said first fluid pressure.

26. The valve according to claim 25, wherein said first seal comprises a first ring and said second seal comprises a second ring.

27. The valve according to claim 26, wherein said first ring is surrounded by said second ring.

28. The valve according to claim 26, wherein said second ring is surrounded by said first ring.

29. The valve according to claim 25, further comprising a first spring element positioned within said housing, said first spring element biasing said first seal into contact with said sealing surface to effect said first fluid tight seal up to said first fluid pressure within said valve.

30. The valve according to claim 29, further comprising a second spring element positioned within said housing, said second spring element biasing said second seal toward said sealing surface.

31. The valve according to claim 25, further comprising a spring element positioned within said housing, said spring element biasing said second seal toward said sealing surface.

32. The valve according to claim 25, wherein said valve closing member comprises a ball rotatably mounted within said housing, said ball having a duct therethrough alignable with said first and said second openings when said closing member is in said open configuration.

33. The valve according to claim 25, further comprising:
said sealing surface of said valve closing member being positioned in facing relation with said second opening when said closing member is in said closed configuration;
a third seal positioned within said housing surrounding said second opening, said third seal being in contact with said sealing surface and effecting a third fluid tight seal up to a third fluid pressure within said valve;
a fourth seal positioned within said housing surrounding said second opening, said fourth seal contacting said sealing surface to effect a fourth fluid tight seal up to a fourth fluid pressure within said valve higher than said third fluid pressure.

34. The valve according to claim 33, wherein said third seal comprises a third ring and said fourth seal comprises a fourth ring.

35. The valve according to claim 34, wherein said third ring is surrounded by said fourth ring.

36. The valve according to claim 34, wherein said fourth ring is surrounded by said third ring.

37. The valve according to claim 33, further comprising a first spring element positioned within said housing, said first spring element biasing said third seal into contact with said sealing surface to effect said third fluid tight seal up to said third fluid pressure within said valve.

38. The valve according to claim 37, further comprising a second spring element positioned within said housing, said second spring element biasing said fourth seal toward said sealing surface.

39. The valve according to claim 33, further comprising a spring element positioned within said housing, said spring element biasing said fourth seal toward said sealing surface.

40. The valve according to claim 33, wherein said valve closing member comprises a ball rotatably mounted within said housing, said ball having a duct therethrough alignable with said inlet and said outlet when said closing member is in said open configuration.
